(19) United States
(12) Patent Application Publication
(10) Pub. No.: US 2023/0113385 A1
(43) Pub. Date: Apr. 13, 2023

(54) Vehicle Terminal, System and Method

(71) Applicants: Hyundai Motor Company, Seoul (KR); Kia Corporation, Seoul (KR)

(72) Inventor: Sunghwan Moon, Incheon (KR)

(21) Appl. No.: 17/643,547

(22) Filed: Dec. 9, 2021

(30) Foreign Application Priority Data
Sep. 29, 2021 (KR) 10-2021-0128790

(51) Int. Cl. G06Q 30/04; G06Q 50/30

(52) U.S. Cl. CPC G06Q 30/04; G06Q 50/30

(57) ABSTRACT

In an embodiment a vehicle terminal includes an input/output unit configured to receive destination information from a driver using a car sharing vehicle provided by a car sharing service, a position detection unit configured to detect a position of the sharing vehicle, a control unit configured to calculate a use time of the sharing vehicle and provide information of whether an occupant is present in the sharing vehicle and about a distance moved based on the detected positions and a vehicle communication unit configured to communicate with a server and transmit the use time, the information of whether the occupant is present and about the distance moved so that time fares are calculable.

### CROSS-REFERENCE TO RELATED APPLICATIONS

This application claims the benefit of Korean Patent Application No. 10-2021-0128790, filed in the Korean Intellectual Property Office on Sep. 29, 2021, which application is hereby incorporated herein by reference.

### TECHNICAL FIELD

The present invention relates to a method for calculating fares for a driver who is both a car sharing service user and a car hailing service provider and an occupant who is a car hailing service user, respectively, and a system for providing the method thereof, in a business model of providing a car hailing service to an occupant with a car sharing vehicle rented by the driver using a car sharing service.

### BACKGROUND

Globally, a sharing economy concept is rapidly established in social fields. There are services where people share their house to others (e.g., Airbnb), services where people share their office spaces with others (e.g., WeWork), and the like. In addition, people's attention in car sharing and car hailing, which are the sharing economy concept in the car market, has been increased.

The car sharing means a service that uses the vehicle for a predetermined time by renting the vehicle in a time unit instead of purchasing the vehicle. In car sharing services, fares are calculated according to rental time and moving distance. In addition, a refueling fare is calculated as a credit card in the vehicle, and the payment is replaced with a payment according to the moving distance. For example, companies that provide car sharing services are Socar, Green car and the like.

Car hailing means a service in which a customer calls a vehicle of a person, not a taxi driver, pays a constant fare, and rides together to a desired destination. Alternatively, car hailing also refers to a mobility service that connects a customer who wants to move and a provider who provides a mobile service in real time. Since the vehicle comes at desired time and to the place of the consumer, the car hailing has an advantage of being more convenient than the car sharing service in which the customer needs to go to a defined place. For example, companies that provide car hailing service are Uber, Grab and the like.

Recently, a business model for providing a car hailing service to an occupant with a car sharing vehicle rented by the driver using the car sharing service has appeared and the supply and demand thereof has increased.

### SUMMARY

Therefore, it is desirable to develop a systematic and reasonable fare calculation method that can be applied to a driver who is both a car sharing service user and a car hailing service provider, and an occupant who uses a car hailing service user, respectively.

Embodiments provide a method for calculating a car sharing fare and a car hailing fare to a driver who is both a car sharing service user and a car hailing service provider, and an occupant who is a car hailing service user, respectively, and a fare calculation system of providing the method thereof.

An exemplary embodiment provides a fare calculation system as a system for calculating a sharing fare for the use of a sharing car and a hailing fare for a car hailing service provided to an occupant by the sharing vehicle, including a server configured to calculate a first time fare paid by a driver by applying a first ratio to a sharing time fare calculated based on the use time of the sharing vehicle and calculate a second time fare paid by the occupant by applying a second ratio to the sharing time fare, a server configured to calculate a first time fare paid by a driver by applying a first ratio to a sharing time fare calculated based on the use time of the sharing vehicle and calculate a second time fare paid by the occupant by applying a second ratio to the sharing time fare, calculate the hailing fare paid by the occupant by multiplying the second distance fare by a predetermined multiple.

Another exemplary embodiment provides a fare calculation system as a system for calculating a sharing fare for the use of a sharing car and a hailing fare for a car hailing service provided to a plurality of occupants by the sharing vehicle, including a server configured to calculate a first time fare paid by a driver by applying a first ratio to a sharing time fare calculated based on the use time of the sharing vehicle and calculate a second time fare paid by each of the plurality of occupants by applying a second ratio to the sharing time fare, calculate a first distance fare paid by the driver by applying a third ratio to a sharing distance fare calculated based on the moving distance of the sharing vehicle and calculate a second distance fare paid by each of the plurality of occupants by applying a fourth ratio corresponding to each of the plurality of occupants to the sharing distance fare, and calculate the hailing fare paid by each of the plurality of occupants by multiplying the second distance fare paid by each of the plurality of occupants by a predetermined multiple.

Yet another exemplary embodiment of provides a fare calculation method as a method for calculating a sharing fare for the use of a sharing car and a hailing fare for a car hailing service provided to an occupant by the sharing vehicle, including the steps of determining whether a service period divided according to an increase or decrease of the number of occupants riding in the sharing vehicle is set, determining whether the number of occupants riding in the sharing vehicle is in plural in the set service period when the service period is set as the determining result, and calculating a driver fare paid by the driver and an occupant fare paid by the occupant for the set service period when the number of occupants is single as the determining result, wherein the calculating of the driver fare paid by the driver and the occupant fare paid by the occupant includes calculating a first time fare paid by a driver by applying a first ratio to a sharing time fare calculated based on the use time of the sharing vehicle and calculating a second time fare paid by the occupant by applying a second ratio to the sharing time fare, calculating a first distance fare paid by the driver by applying a third ratio to a sharing distance fare calculated based on the moving distance of the sharing vehicle and calculating a second distance fare paid by the occupant by applying a fourth ratio to the sharing distance fare, and calculating the hailing fare paid by the occupant by multiplying the second distance fare by a predetermined multiple.

According to an embodiment, it is possible to provide a fare calculation method essentially required for a business model of providing a car hailing service to an occupant with a car sharing vehicle rented by a driver using a car sharing service.

### BRIEF DESCRIPTION OF THE DRAWINGS

FIG. 1 is a diagram for describing a fare calculation system for a car sharing service and a car hailing service according to an exemplary embodiment;

FIG. 2 is a block diagram for describing a configuration of a vehicle terminal of FIG. 1 in detail;

FIG. 3 is a block diagram for describing a configuration of a driver terminal of FIG. 1 in detail;

FIG. 4 is a block diagram for describing a configuration of an occupant terminal of FIG. 1 in detail;

FIG. 5 is a block diagram for describing a configuration of a server of FIG. 1 in detail; and

FIG. 6 is a flowchart for describing a fare calculation method for a car sharing service and a car hailing service according to an exemplary embodiment.

### DETAILED DESCRIPTION OF THE ILLUSTRATIVE EMBODIMENTS

Hereinafter, exemplary embodiments disclosed in this specification will be described in detail with reference to the accompanying drawings and the same or similar components are denoted by the same reference numerals regardless of a sign of the drawing, and duplicated description thereof will be omitted. Suffixes “module”, “block”, and “unit” for components used in the following description are given or mixed in consideration of easy preparation of the specification only and do not have their own distinguished meanings or roles. Further, in describing an exemplary embodiment disclosed in the present disclosure, a detailed description of related known technologies will be omitted if it is decided that the detailed description makes the gist of the exemplary embodiment of the present disclosure unclear. Also, it should be understood that the appended drawings are intended only to help understand embodiments disclosed in the present document and do not limit the technical principles and scope of the present invention; rather, it should be understood that the appended drawings include all of the modifications, equivalents or substitutes described by the technical principles and belonging to the technical scope of the present invention.

Terms including an ordinary number, such as first, second, etc., may be used for describing various constituent elements, but the constituent elements are not limited by the terms. The terms are used only to discriminate one component from the other component.

It should be understood that, when it is described that a component is “coupled” or “connected” to the other component, the component may be directly coupled or connected to the other component, but there may be another component therebetween. In contrast, it should be understood that, when it is described that a component is “directly coupled” or “directly connected” to the other component, it should be understood that no component is present therebetween.

The terms “comprising,” or “having,” are inclusive and therefore specify the presence of stated features, integers, steps, operations, elements, and/or components, but do not preclude the presence or addition of one or more other features, integers, steps, operations, elements, components, and/or groups thereof.

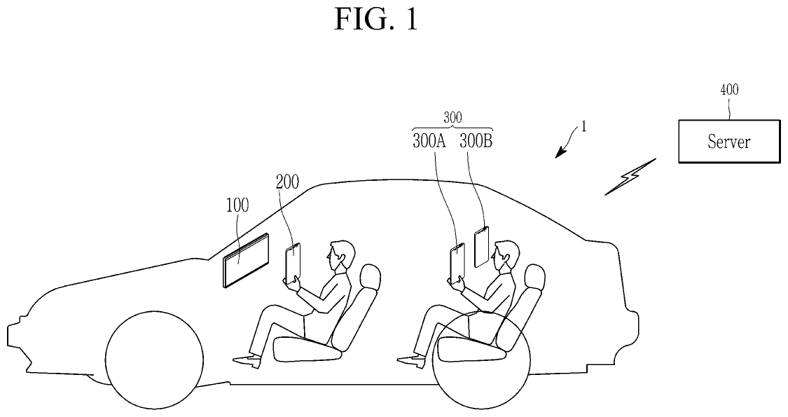

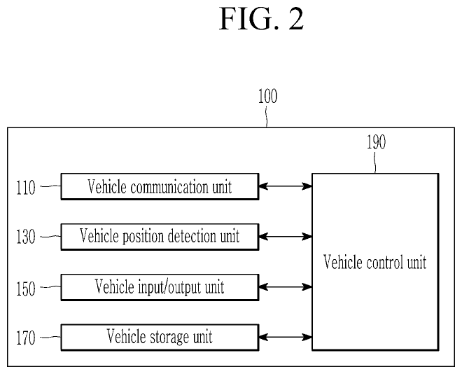

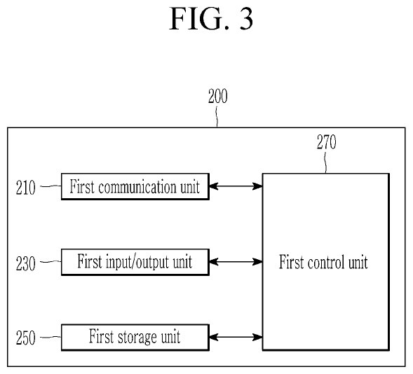

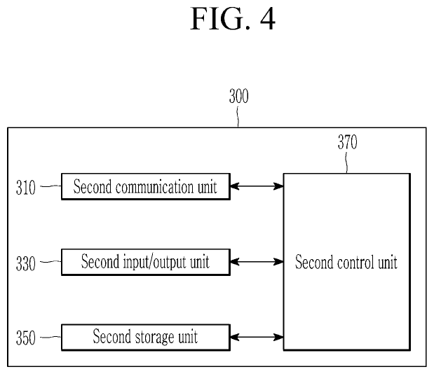

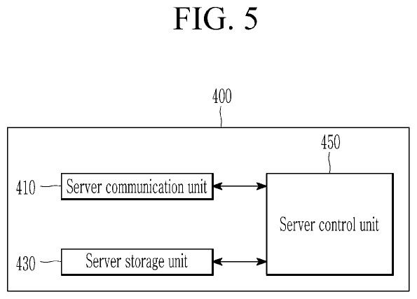

FIG. 1 is a diagram for describing a fare calculation system for a car sharing service and a car hailing service according to an exemplary embodiment, FIG. 2 is a block diagram for describing a configuration of a vehicle terminal of FIG. 1 in detail, FIG. 3 is a block diagram for describing a configuration of a driver terminal of FIG. 1 in detail, FIG. 4 is a block diagram for describing a configuration of an occupant terminal of FIG. 1 in detail, and FIG. 5 is a block diagram for describing a configuration of a server of FIG. 1 in detail.

Referring to FIG. 1, the fare calculation system includes a vehicle terminal 100, a driver terminal 200, an occupant terminal 300, and a server 400.

According to an exemplary embodiment, the driver may be both a car sharing service user and a car hailing service provider. The occupant may be a car hailing service user.

The fare calculation system may allocate and charge a sharing fare that belongs to a vehicle owner as the provider of the car sharing service, to the driver and the occupant at a predetermined rate. The sharing fare may include a sharing time fare calculated based on a time using a sharing vehicle 1 and a sharing distance fare calculated based on a distance moving using the sharing vehicle 1.

The fare calculation system may charge a hailing fare that belongs to a driver as the provider of the car hailing service to the occupant. The hailing fare may be cost paid to receive the hailing service of the driver to a destination while the occupant rides in the sharing vehicle 1. For example, the fare calculation system may calculate a hailing fare by multiplying the sharing distance fare calculated based on the moving distance using the sharing vehicle 1 by a predetermined multiple n.

The vehicle terminal 100 is a terminal which is mounted on the sharing vehicle 1 provided to the car sharing service. For example, the vehicle terminal 100 may be mounted with AVN (AUDIO, VIDEO, NAVIGATION), WI (In-Vehicle Infotainment) system, and the like. When the sharing vehicle 1 is matched with a driver requesting the car sharing service, the vehicle terminal 100 may receive information about a rental time and a driver of the sharing vehicle 1, and the like from the server 400. According to an exemplary embodiment, the vehicle terminal 100 may transmit information about a total moving distance at which the sharing vehicle 1 moves for a rental period, whether the occupant is riding, a using time when the occupant rides, and a moving distance while the occupant is riding, and the like, to the server 400.

Referring to FIG. 2, the vehicle terminal 100 includes a vehicle communication unit 110, a vehicle position detection unit 130, a vehicle input/output unit 150, a vehicle storage unit 170, and a vehicle control unit 190.

The vehicle communication unit no may be connected to a communication network to transmit and receive data to and from the server 200. The vehicle communication unit 110 may be connected to the communication network through a wireless communication protocol such as GSM/3GPP-based communication schemes (GSM, HSDPA, and LTE Advanced), 3GPP2-based communication schemes (CDMA, etc.), or WiMAX, but is not limited thereto.

The vehicle position detection unit 130 may detect a position of the vehicle terminal 100. For example, the vehicle position detection unit 130 may detect the position of the vehicle terminal 100 based on a GPS signal transmitted from a global positioning system (GPS) satellite, but is not limited thereto. As another example, the vehicle position detection unit 130 may communicate with a plurality of base stations to detect the position of the vehicle terminal 100.

The vehicle input/output unit 150 displays an interface for receiving a destination to receive destination information from the driver. In addition, the vehicle input/output unit 150 may display a path to the destination on a prestored map or a map transmitted from the server 400. At this time, the path to the destination may be transmitted from the server 400.

The vehicle input/output unit 150 may include, for example, a touch input means such as a keypad, to receive the destination information from the driver. The vehicle input/output unit 150 may include, as another example, a display means such as a plasma display panel (PDP) for displaying the information described above, and may also be implemented in a touch screen form capable of inputting and outputting.

The vehicle storage unit 170 may store data, an algorithm, and the like required for operating with the vehicle terminal 100. According to an exemplary embodiment, the vehicle storage unit 170 may store a first application related with the car sharing service, a navigation program displaying destination information received from the driver through the vehicle input/output unit 15o, a position of the vehicle terminal 100 detected by the vehicle position detection unit 13o, and a path to the destination, and the like, but is not limited thereto.

The vehicle control unit 190 may control the vehicle terminal 100 as a whole to provide the car sharing service to the driver. For example, the vehicle control unit 190 may transmit information about whether the occupant is riding, a using time when the occupant rides, and a moving distance while an occupant is riding, to the server 400, through the vehicle communication unit no.

The driver terminal 200 is a terminal held by the driver providing the car hailing service. For example, the driver terminal 200 may be equipped with a first application (hereinafter, first app) for using the car sharing service and a second application (hereinafter, second app) for using the car hailing service. According to an exemplary embodiment, when the driver terminates the driving of the sharing vehicle 1, the server 400 may transmit information about a total driver fare charged to the driver to the driver terminal 200. Further, the server 400 may transmit information about a total occupant fare to the driver terminal 200 in order to transmit the total occupant fare received from the occupant to the driver.

Referring to FIG. 3, the driver terminal 200 includes a first communication unit 210, a first input/output unit 230, a first storage unit 250, and a first control unit 270.

The first communication unit 210 may be connected to a communication network via various wireless communication protocols to transmit and receive data to and from a server 400.

The first input/output unit 230 displays various information required for the car sharing service and the car hailing service to the driver and receives various inputs from the driver. For example, the first input/output unit 230 may include a touch input means such as a keypad, to receive various information from the driver. The first input/output unit 230 may include a display means such as a plasma display panel (PDP) for displaying various information required for the car sharing service and the car hailing service to the driver, and may also be implemented in a touch screen form capable of inputting and outputting.

The first storage unit 250 may store various programs required for operating the driver terminal 200. For example, the first storage unit 250 may store a first app for using the car sharing service and a second app for providing the car hailing service.

The first control unit 270 may control the overall driver terminal 200 so that the driver uses the car sharing service and provides the car hailing service. For example, the driver may transmit information input through the first input/output unit 230 to the server 400 through the first communication unit 210. Further, the first control unit 270 may receive information about a total driver fare from the server 400 through the first communication unit 210 and display the received information about the total driver fare through the first input/output unit 230.

The occupant terminal 300 is a terminal held by the occupant using the car hailing service. For example, the occupant terminal 300 may be mounted with a second application (hereinafter, second app) for using the car hailing service. According to an exemplary embodiment, the server 400 may transmit information about a total occupant fare to the occupant terminal 300 when the occupant gets off from the sharing vehicle 1.

Referring to FIG. 4, the occupant terminal 300 may includes a second communication unit 310, a second input/output unit 33o, a second storage unit 350, and a second control unit 370. For example, the occupant terminal 300 may be a portable terminal device equal to or similar to the driver terminal 200.

The second communication unit 310 may be connected to a communication network via various wireless communication protocols to transmit and receive data to and from a server 400.

The second input/output unit 330 displays various information required for the car sharing service to the occupant and receives various inputs from the occupant. For example, the second input/output unit 330 may include a touch input means such as a keypad, to receive various information from the occupant. The second input/output unit 330 may include a display means such as a plasma display panel (PDP) for displaying various information required for the car hailing service to the occupant, and may also be implemented in a touch screen form capable of inputting and outputting.

The second storage unit 350 may store various programs required for operating the occupant terminal 300 and a second app for using the car hailing service.

The second control unit 370 may control the overall occupant terminal 300 so that the occupant may use the car hailing service. For example, the occupant may transmit information input through the second input/output unit 330 to the server 400 through the second communication unit 310. Further, the second control unit 370 may receive information about a total driver fare from the server 400 through the second communication unit 310 and display the received information about the total driver fare through the second input/output unit 330.

The server 400 may calculate a sharing fare for using the car sharing service and a hailing fare for using the car hailing service and charge the calculated fares to the driver and the occupant in a business model in which the driver renting the sharing vehicle 1 using the car sharing service provides the car hailing service to N occupants.

Referring to FIG. 5, the server 400 includes a server communication unit 410, a server storage unit 430, and a server control unit 450.

The server communication unit 410 may transmit and receive data to and from each of the vehicle terminal 100, the driver terminal 200, and the occupant terminal 300 using a wireless communication protocol capable of communicating with each of the vehicle terminal 100, the driver terminal 200, and the occupant terminal 300.

The server storage unit 430 may store various information required for calculating a sharing fare and a hailing fare. For example, the server storage unit 430 may store information about various parameters required for calculating the sharing fare and the hailing fare, whether the occupant is riding, a usage time while the occupant is riding, and a moving distance while the occupant is riding.

The server control unit 450 may calculate a total driver fare and a total occupant fare using various information required for calculating the sharing fare and the hailing fare. The server control unit 450 may transmit information about a total driver fare to the driver terminal 200 through the server communication unit 410. Further, the server control unit 450 may transmit the total occupant fare to the occupant terminal 300 through the server communication unit 410.

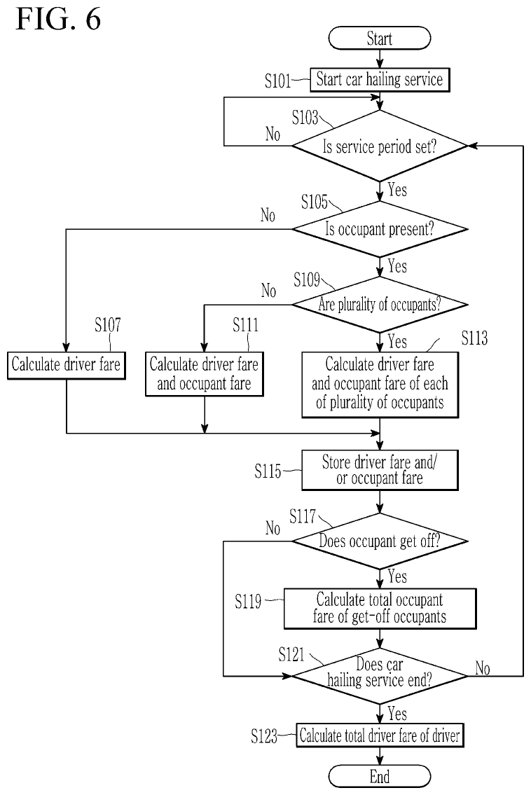

FIG. 6 is a flowchart for describing a fare calculation method for a car sharing service and a car hailing service according to an exemplary embodiment.

Referring to FIGS. 1 to 6, the fare calculation method for the car sharing service and the car hailing service and the fare calculation system for providing the method thereof will be described in detail.

Referring to FIG. 6, when the driver starts the car hailing service using the sharing vehicle 1 (S101), the server 400 determines whether a service period is set (S103). At this time, the sharing vehicle 1 may be a vehicle rented by the driver using the car sharing service.

The service period may be divided according to a change (increase or decrease) in the number N of occupants riding in the sharing vehicle 1 (hereinafter, the occupant number). According to an exemplary embodiment, while the sharing vehicle 1 is operating, the server 400 may determine a start point and an end point of the service period based on a point where the occupant number N is changed. According to an exemplary embodiment, in Table 1 below, the driver fare and/or the occupant fare may be calculated by dividing the service period into a zeroth period, a first period, a second period, a third period, a fourth period, and a fifth period based on the point where the occupant number N is changed.

In Table 1 below, the server 400 may determine a point (that is, a point where a first occupant A rides) where the occupant number increases from 0 to 1 as an end point of the zeroth period. That is, when the occupant number N riding in the sharing vehicle 1 is zero, the server 400 may determine that at a point (that is, a point where the first occupant A rides) where an occupant newly rides, a previous service period (zeroth period) corresponding to the occupant number N of 0 ends and a new service period (the first period) corresponding to the occupant number N of 1 starts. According to an exemplary embodiment, when the service period ends, the ended service period may be in a set state capable of calculating the fare.

Similarly, the server 400 may set a point (i.e., a point where a second occupant B rides) where the occupant number increases from 1 to 2 as an end point of the first period. Then, the server 400 may determine that the first period ends (or is set) and the second period newly starts. Further, the server 400 may set a point (i.e., a point where a third occupant C rides) where the occupant number increases from 2 to 3 as an end point of the second period. Then, the server 400 may determine that the second period ends (or is set) and the third period newly starts. Further, the server 400 may set a point (i.e., a point where the third occupant C gets off) where the occupant number decrease from 3 to 2 as an end point of the third period. Then, the server 400 may determine that the third period ends (or is set) and the fourth period starts. Through the same determining process, the fourth period and the fifth period may be set.

Next, as the determining result, if the service period is not set (S103, No), the server 400 may determine that the current service period continuously extends.

Next, as the determining result, if the service period is set (S103, Yes), the server 400 determines whether the occupant riding in the sharing vehicle 1 exists in the set service period (S105).

Next, as the determining result, when the occupant does not ride (Sio5, No), the server 400 may calculate a sharing time fare and a sharing distance fare for the set service period and determine the calculated sharing time fare and sharing distance fare as a driver fare paid by the driver (S1o7).

The server may calculate the sharing time fee based on the use time of the sharing vehicle 1 in the set service period. In addition, the server 400 may calculate the sharing distance fare based on the moving distance of the sharing vehicle 1 in the set service period. The server 400 may determine the calculated sharing time fare and the sharing distance fare to the driver fare paid by the driver.

Table 1 below is an example for understanding the calculation of the sharing fare and the hailing fare.

TABLE 1

| | | | | | Second | Third period | | | |
|---|---|---|---|---|---|---|---|---|---|
| | | | Zeroth | | period | (2 hr, 10 km) | Fourth period | Fifth period | |
| | | | period | First period | (4 hr, 20 km) | Occupant C | (1 hr, 5 km) | (1 hr, 5 km) | |
| Cost load | | | (2hr, | (2 hr, 10 km) | Occupant B | | | | Cost |
| (1000 won/hr) | | | 10 km) | Occupant A | | | | | attribu- |
| (200 won/1 km) | | | Driver | | | | | | tion |
| Owner | Time | 1. Driver | D = 1 | D = 1/2(1,000 | D = 1/3 | D = 1/4 -> (500 won) | D = 1/3(333 won) | D = 1/2 (5,00 | 11,998 |
| | fare | 2. Occu- | (2,000 | won) | (1,333 won) | A = 1/4 -> (500 won) | A = 1/3(333 won) | won) | won |
| | (FC) | pant | won) | A = 1/2(1,000 | A = 1/3 | B = 1/4 -> (500 won) | B = 1/3(333 won) | B = 1/2 (5,00 | |
| | | | | won) | (1,333 won) | C = 1/4 -> (500 won) | | won) | |
| | | | | | B = 1/3 | | | | |
| | | | | | (1,333 won) | | | | |
| | Distance fare (AC) | 1. Driver 2. Occu- pant (B = 0, C = 0.5) | D = 1 (2,000 won) | A = 1 (2,000 won) | $\begin{matrix}A = \frac{C}{1 + C} \\ ( = 1 , 333 ) \\ B = \frac{1}{1 + C} \\ ( = 2 , 667 )\end{matrix}$ | $\begin{matrix}A = \frac{{C}^{2}}{1 + C + {C}^{2}} \\ ( = 286 won ) \\ B = \frac{{C}^{1}}{1 + C + {C}^{2}} \\ ( = 571 won ) \\ C = \frac{1}{1 + C + {C}^{2}} \\ ( = 1 , 143 won )\end{matrix}$ | $\begin{matrix}A = \frac{C}{1 + C} \\ ( = 333 won ) \\ B = \frac{C}{1 + C} \\ ( = 667 won )\end{matrix}$ | $B = 1 ( 1 , 00 )$ | 12,000 won |
| Driver | Hailing | Occupant | — | [Total: 6,000 | [Total: 12,000 | [Total: 6,000 won] | [Total: 3,000 | [Total: 3,000 | 30,000 |
| | fare | | | won] | won) | A = 3AC_1 (858 | won] | won] | won |
| | (HCt) | | | A = 3 × | A = 3AC_1 | won) | [symbol] A = 3AC1 | B = 3AC_2 | |
| | | | | AC_1 | (4,000 won) | B = 3AC_2 (1,713 | (1,000 won) | (3,000 won) | |
| | | | | (6,000) | B = 3AC_2 | won) | [symbol] B = 3AC_2 | | |
| | | | | | (8,000 won) | C = 3AC_3 (3,429 | (2,000 won) | | |
| | | | | | | won) | | | |

| | | | | | | |
|---|---|---|---|---|---|---|
| Cost settlement | 1. D = | 1. D = 1,000 | 1. D = 1,333 | 1. D = 500 won | 1. D = 333 won | 1. D = 500 won |
| | 4,000 | won | 2. A = 6,667 | 2. A = 1,644 won | 2. A = 1,666 won | 2. B = 4500 won |
| | won | 2. A = 9,000 | 3. B = 12,000 | 3. B = 2,784 won | 3. B = 3,000 won | |
| | | won | | 4. C = 5,072 won | | |

Referring to Table 1 above, it is assumed that the driver rented the sharing vehicle 1 for 12 hours (rental time) and provided the car hailing service while driving the rented sharing vehicle 1 at total 60 km. It is assumed that in the zeroth period, the occupant did not ride, in the first period, a single occupant (N=1) rode in the sharing vehicle 1, and in the second to fifth periods, a plurality of occupants (N>1) rode in the sharing vehicle 1. Further, it is assumed that a sharing time fare per unit time (e.g., 1 hour) is 1000 won and a sharing distance fare per unit distance (e.g., 1 km) is 200 won.

In Table 1 above, the zeroth period ends at the point where the first occupant A rides, and the ended service period (zeroth period) may be a set state capable of calculating the fare. That is, the zeroth period may be an example of setting for the period where the occupant does not ride (step S107).

In the zeroth period, for example, the server 400 may calculate a driver fare for the zeroth period by adding a sharing time fare (2,000 won=2 hr×1,000 won) for 2 hours and a sharing distance fare (2,000 won=10 km×200 won/1 km) for 10 km. That is, when the occupant dose not ride, the sharing fare (the sharing time fare and the sharing distance fare) as the use fare of the car sharing service may be paid by the driver.

Next, as the determining result, when the occupant rides (Sio5, Yes), the server 400 determines whether a plurality of occupants riding in the sharing vehicle 1 exist in the set service period (S109).

Next, as the determining result, when the occupant is single (S109, No), the server calculates a driver fare paid by the driver and an occupant fare paid by the occupant in the set service period (Sm).

In step Sm, the server 400 may calculate a first time fare paid by the driver by applying a first ratio DTR to the sharing time fare calculated based on the use time of the sharing vehicle 1. Further, the server 400 may calculate a second time fare paid by the occupant by applying a second ratio PTR to the sharing time fare.

The first ratio DTR may be calculated by the following Equation 1. The second ratio PTR may be calculated by the following Equation 2. For example, in the period (e.g., the first period) where the occupant riding in the sharing vehicle 1 is single, the occupant number N may substitute 1 for Equations 1 and 2. At this time, the first parameter A is an integer of o or more and 1 or less (0≤A≤1), and N is the total number of occupants (hereinafter, the occupant number). The first parameter A is a parameter that indicates a share rate of the driver and the occupant for a sharing time fare FC and may be irrelevant to the occupant number N.

$$DTR = \frac{A}{A + ( 1 - A ) \times N} \qquad Equation 1$$

$$PTR = \frac{1 - A}{A + ( 1 - A ) \times N} \qquad Equation 2$$

According to an exemplary embodiment, the server 400 may allocate the sharing time fare FC to the driver and the occupant at the same share rate. At this time, the first parameter A is 1/2. When the occupant number is 1 (N=1), the first ratio DTR is 1/2 by Equation 1, and the second ratio PTR is 1/2 by Equation 2. Then, the server 400 may burden the sharing time fare FC to the driver and the first occupant A at a 1/2 ratio. Hereinafter, in the calculation, it is assumed that the same ratio is applied to the driver and the occupant, and the first parameter A is applied with 0.5. However, it is not limited thereto, and the ratio of the driver and the occupant to the sharing time fare FC may be variously set.

In step S111, the server 400 may calculate a first distance fare paid by the driver by applying a third ratio DDR to a sharing distance fare AC calculated based on the moving distance of the sharing vehicle 1. The server 400 may calculate a second distance fare paid by the occupant by applying a fourth ratio PDRt to the sharing distance fare AC.

The third ratio DDR may be calculated by the following Equation 3. The fourth ratio PDRt may be calculated by the following Equation 4. For example, in the period (e.g., the first period) where the occupant riding in the sharing vehicle 1 is single, the occupant number N may substitute 1 for Equations 2 and 3. At this time, the second parameter B is an integer of o or more and 1 or less (o≤B≤1), and N is the occupant number. The second parameter B is a parameter that indicates a share ratio of the driver and the occupant for the sharing distance fare AC and may be irrelevant to the occupant number N. The third parameter C is a parameter that indicates a share ratio between the plurality of occupants.

$$DDR = B \qquad Equation 3$$

$${PDR}_{t} = ( 1 - B ) \times \frac{{C}^{N - t}}{{\sum }_{k = 1}^{N} {C}^{k - 1}} \qquad Equation 4$$

According to an exemplary embodiment, when there is an occupant riding in the sharing vehicle 1 (e.g., a single of occupant rides), the server 400 may burden all the sharing distance fare AC calculated based on a reference distance to the occupant. At this time, the second parameter B may be 0. If the occupant is one (n=1), the third ratio DDR is 0 by Equation 1 and the fourth ratio PDRt is 1 by Equation 4. Then, the server 400 may allocate the sharing distance fare AC to the first occupant A at the first ratio. Hereinafter, it is assumed that when the occupant rides in the sharing vehicle 1 regardless a single or multiple occupants, all the sharing distance fare AC is burdened by the occupant, wherein the second parameter B is applied with 0. However, it is not limited thereto, and the ratio of the driver and the occupant for the sharing distance fare AC may be variously set.

In step Sill, the server 400 may calculate the hailing fare paid by the occupant by multiplying the second distance fare by a predetermined multiple. At this time, n is an integer of 0 or more. Hereinafter, the predetermined multiple n is assumed as 3 for convenience, but is not limited thereto, and may be set to various positive integers.

In step S111, when an additional fare SC occurs in the use of the sharing vehicle 1, the server may calculate a first additional fare SC1 paid by the driver by applying a fifth ratio SDR to the additional fare SC. The server 400 may further calculate a second additional fare SC2 paid by the occupant by applying a sixth ratio PSDRₜ to the additional fare SC. The additional fare SC may be costs occurring when the sharing vehicle i uses paid roads, paid tunnels or paid bridges generating costs, but is not limited thereto, and may include various additional costs capable of occurring during the driving of the sharing vehicle i.

The fifth ratio SDR may be calculated by the following Equation 5. The sixth ratio PSDRₜ may be calculated by the following Equation 6. For example, in the period (e.g., the first period) where the occupant riding in the sharing vehicle i is single, the occupant number N may substitute i for Equations 5 and 6. At this time, a fourth parameter D is an integer of o or more and i or less (o≤D≤1), and N is the occupant number. The fourth parameter D is a parameter that indicates a share rate of the driver and the occupant for the additional fare SC and may be irrelevant to the occupant number N. A fifth parameter E is a parameter indicating a share rate among the plurality of occupant.

$$SDR = D \qquad Equation 5$$

$${PSDR}_{t} = ( 1 - D ) \times \frac{{E}^{N - t}}{{\sum }_{k = 1}^{N} {E}^{k - 1}} \qquad Equation 6$$

According to an exemplary embodiment, when there is an occupant riding in the sharing vehicle i (e.g., a single of occupant rides), the server 400 may burden all the additional fare SC to the occupant. At this time, the fourth parameter D may be o. If the occupant is one (n=1), the fifth ratio SDR is 0 by Equation 5 and the sixth ratio PSDRₜ is 1 by Equation 6. Then, the server 400 may allocate a second addition fare SC2 to the first occupant A at the first ratio. Hereinafter, it is assumed that when the occupant rides in the sharing vehicle 1 regardless a single or multiple occupants, all the addition fare SC is burdened by the occupant, wherein the fourth parameter D is applied with o. However, it is not limited thereto, and the ratio of the driver and the occupant for the addition fare SC may be variously set.

In Table 1 above, for example, the first period ends at the point where the second occupant B rides, and the ended service period (first period) may be a set state capable of calculating the fare. That is, the first period may be an example of setting for the period where the occupant riding in the sharing vehicle 1 is single (step Sill).

In the first period of Table 1, the server 400 calculates a sharing time fare (2,000 won=2 hr×1,000 won) for the first period. In addition, the server 400 calculates a first time fare, 1,000 won (1,000 won=2,000 won×1/2) paid by the driver by applying the first ratio DTR, 1/2 to the sharing time fare (FC=2000 won) for the first period. The server 400 may calculate a second time fare, 1,000 won (1,000 won=2,000 won×1/2) paid by the first occupant A by applying the second ratio DTR, 1/2 to the sharing time fare (FC=2000 won) for the first period.

In the first period of Table 1, the server 400 calculates a sharing distance fare (2,000 won=10 km×200 won/1 km) for the first period. According to an exemplary embodiment, when the occupant rides, the second parameter B may be selected as 0 so that the sharing distance fare is not burdened to the driver, but burdened to only the occupant. Then, the server 400 may calculate a first distance fare, o won paid by the driver by applying the third ratio DDR to the sharing distance fare (AC=2,000 won) for the first period. In addition, the server 400 may calculate a first distance fare, 2,000 won paid by the first occupant A by applying the fourth ratio PDRt to the sharing distance fare (2,000 won) for the first period. At this time, the server 400 may calculate the third ratio DDR and the fourth ratio PDRt by substituting the second parameter (B=0) and the occupant number N, 1 for Equations 3 and 4, respectively.

In the first period of Table 1, the server 400 may calculate a hailing fare, 6,000 paid by the first occupant A by multiplying the second distance fare (2,000 won) paid by the first occupant A by a predetermined multiple (n=3).

In the fare for the first period, the server 400 may calculate a driver fare, 1,000 won, paid by the driver by adding the first time fare (1,000 won) and the first distance fare (0 won). The server 400 may calculate an occupant fare, 9,000 won, paid by the first occupant A by adding the second time fare (1,000 won), the second distance fare (2,000 won), and the hailing fare (6,000 won).

Although not illustrated in the first period of Table 1 above, it may be assumed that the additional fare SC, 1,000 won, occurs in the first period. Then, the server 400 may calculate an occupant fare, 10,000 won, paid by the first occupant A by further adding a second addition fare (1,000 won) to the second time fare (1,000 won), the second distance fare (2,000 won), and the hailing fare (6,000 won). In summary, the server 400 may allocate a first additional fare SC1 and a second additional fare SC2 to the driver and the occupant with respect to a period where the additional fare SC occurs.

Next, as the determining result, when there are the plurality of occupants (S109, Yes), the server 400 may calculate a driver fare paid by the driver and an occupant fare paid by each of the plurality of occupants for the predetermined service period (S113).

In step S113, the server 400 may calculate a first time fare paid by the driver by applying the first ratio DTR to the sharing time fare calculated based on the use time of the sharing vehicle 1. Further, the server 400 may calculate a second time fare paid by each of the plurality of occupants by applying the second ratio PTR to the sharing time fare.

The first ratio DTR may be calculated by Equation 1. The second ratio PTR may be calculated by Equation 2. According to an exemplary embodiment, the server 400 may burden the sharing time fare FC to the driver and the occupant at the same share rate. At this time, the first parameter A is 1/2. When the occupant number is 2 (N=2), the first ratio DTR is 1/3 by Equation 1, and the second ratio PTR is 1/3 by Equation 2. Then, the server 400 may burden the sharing time fare FC to the driver, the first occupant A, and the second occupant B at a 1/3 ratio, respectively.

In step S113, the server 400 may calculate a first distance fare paid by the driver by applying a third ratio DDR to a sharing distance fare AC calculated based on the moving distance of the sharing vehicle 1. The server 400 may calculate a second distance fare paid by each of the plurality of occupants by applying the fourth ratio PDRt corresponding to each of the plurality of occupants to the sharing distance fare AC.

The third ratio DDR may be calculated by Equation 3. The fourth ratio PDRt may be calculated by Equation 4. According to an exemplary embodiment, when there is a plurality of occupants in the sharing vehicle 1, the server 400 may burden the sharing distance fare AC equally to the plurality of occupants without burdening the sharing distance fare AC to the driver. At this time, the second parameter B may be o and the third parameter C may be 0.5. For example, when the occupant number is 2 (N=2), the third ratio DDR is 0 by Equation 3.

The fourth ratio PDRt may be determined according to an order in which the occupants ride in the sharing vehicle 1 by Equation 4. Specifically, a fourth ratio PDRt applied to the first occupant A first riding (t=1) is 1/3 by Equation 4. A fourth ratio PDR2 applied to the second occupant B second riding (t=2) is 2/3 by Equation 4.

In step S113, the server 400 may calculate the hailing fare paid by each of the plurality of occupants by multiplying the second distance fare paid by each of the plurality of occupants by a predetermined multiple.

The server 400 may allocate a hailing fare HCt calculated by multiplying a sharing distance fare Act paid by the occupant by a predetermined multiple n in the sharing distance fare AC to the occupant. For example, the hailing fare HCt applied to each of the plurality of occupants may be calculated by the following Equation 7.

HC_t=AC_t×n Equation 7:

A second distance fare ACt corresponding to each of the plurality of occupants is determined according to an order t of riding in the sharing vehicle 1, and the server 400 may calculate the hailing fare HCt corresponding to each of the plurality of occupants by multiplying the second distance fare Act determined according to the order t of riding in the sharing vehicle 1 by the predetermined multiple n. The hailing fare HCt corresponding to each of the plurality of occupants may vary according to the order t of riding in the sharing vehicle 1. Hereinafter, n is an integer of 0 or more. Hereinafter, in the calculation, n is assumed as 3. At this time, the applying of 3 to the multiple n is an example, and in order to calculate an appropriate hailing fare, various positive integers may be selected.

In step S113, when an additional fare SC occurs in the use of the sharing vehicle 1, the server 400 may calculate a first additional fare SCi paid by the driver by applying a fifth ratio SDR to the additional fare SC. The server 400 may further calculate a second additional fare SC2 paid by the occupant by applying a sixth ratio PSDRt to the additional fare SC.

The fifth ratio SDR may be calculated by Equation 5. The sixth ratio PSDRₜ may be calculated by Equation 6. According to an exemplary embodiment, when there is a plurality of occupants in the sharing vehicle 1, the server 400 may burden the additional fare SC equally to the plurality of occupants without burdening the additional fare SC to the driver. At this time, the fourth parameter D may be o and the fifth parameter E may be 0.5.

For example, when the occupant number is 2 (N=2), the fifth ratio SDR is 0 by Equation 5. The sixth ratio PSDRt may be determined according to an order in which the occupants ride in the sharing vehicle 1 by Equation 6. Specifically, a sixth ratio PSDR1 applied to the first occupant A first riding (t=1) is 1/3 by Equation 6. A sixth ratio PSDR2 applied to the second occupant B second riding (t=2) is 2/3 by Equation 6.

For example, in Table 1 above, the second period ends at the point where the third occupant C rides, and the ended service period (second period) may be a set state capable of calculating the fare. That is, the second period may be an example of setting for the period where the plurality of occupants ride in the sharing vehicle 1 (step S113).

In the second period of Table 1, the server 400 calculates a sharing time fare (4,000 won=4 hr×1,000 won) for the second period. In addition, the server 400 may calculate a first time fare, 1,333 won (1,333 won=4,000 won×1/3) paid by the driver by applying the first ratio DTR, 1/3 to the sharing time fare (FC=4000 won) for the second period. The server 400 may calculate a second time fare, 1,333 won (1,333 won=4,000 won×1/3) paid by each of the first occupant A and the second occupant B by applying the second ratio DTR, 1/3 to the sharing time fare (FC=4,000 won) for the second period.

In the second period of Table 1, the server 400 calculates a sharing distance fare (4,000 won=20 km×200 won/1 km) for the second period. According to an exemplary embodiment, the second parameter B may be 0 and the third parameter C may be 0.5. Then, the server 400 may calculate a first distance fare, 0 won paid by the driver by applying the third ratio DDR, 0 to the sharing distance fare (AC=4,000 won) for the second period. In addition, the server 400 may calculate a second distance fare, 1,333 won (1,333 won=4,000 wow×1/3) paid by the first occupant A by applying the fourth ratio PDR1, 1/3 applied to the first occupant A first riding (t=1) to the sharing distance fare (AC=4,000 won) for the second period. In addition, the server 400 may calculate a second distance fare, 2,667 won (2,667 won=4,000 won×2/3) paid by the second occupant B by applying the fourth ratio PDR2, 2/3 applied to the second occupant B second riding (t=2) to the sharing distance fare (4,000 won) for the second period.

In the first period of Table 1, the server 400 may calculate a hailing fare, 6,000 paid by the first occupant A by multiplying the second distance fare (2,000 won) paid by the first occupant A by a predetermined multiple (n=3). In addition, the server 400 may calculate a hailing fare, 8,000 paid by second occupant B by multiplying the second distance fare (4,000 won×2/3) paid by the second occupant B by a predetermined multiple (e.g., n=3).

In the fare of the second period, the server 400 may calculate a driver fare, 1,333 won, paid by the driver by adding the first time fare (1,333 won) and the first distance fare (0 won). In addition, the server 400 may calculate an occupant fare, 6,667 won, paid by the first occupant A by adding the second time fare (1,333 won), the second distance fare (1,333 won), and the hailing fare (4,000 won) corresponding to the first occupant A. In addition, the server 400 may calculate an occupant fare, 6,667 won, paid by the second occupant B by adding the second time fare (1,333 won), the second distance fare (2,667 won), and the hailing fare (8,000 won) corresponding to the second occupant B.

Although not illustrated in the second period of Table 1 above, it may be assumed that the additional fare SC, 3,000 won, occurs in the second period. According to an exemplary embodiment, the fourth parameter D may be 0 and the fifth parameter E may be 0.5. Then, the server 400 may calculate a first additional fare SC1, 0 won paid by the driver by applying the fifth ratio SDR, 0 to the additional fare (SC=3,000 won) for the second period.

In addition, the server 400 may calculate a second additional fare SC2, 1,000 won (1,000 won=3,000 won×1/3) paid by the first occupant A by applying the sixth ratio PSDRi, 1/3 applied to the first occupant A first riding (t=1) to the additional fare (SC=3,000 won) for the second period. In addition, the server 400 may calculate a second additional fare SC2, 2,000 won (2,000 won=3,000 won×2/3) paid by the second occupant B by applying the sixth ratio PSDR2, 2/3 applied to the second occupant B second riding (t=2) to the additional fare (SC=3,000 won) for the second period. Then, the server 400 may calculate an occupant fare, 7,667 won, paid by the first occupant A by adding further the second additional fare (1,000 won) to the second time fare (1,333 won), the second distance fare (1,333 won), and the hailing fare (4,000 won) corresponding to the first occupant A. In addition, the server 400 may calculate an occupant fare, 14,000 won, paid by the second occupant B by adding further the second additional fare (2,000 won) to the second time fare (1,333 won), the second distance fare (2,667 won), and the hailing fare (8,000 won) corresponding to the second occupant B.

In summary, the server 400 may allocate the calculated additional fare SC to the driver and the occupant by applying the fifth ratio SDR and the sixth ratio PSDRt with respect to a period where the additional fare SC occurs. Hereinafter, even in the third period to the fifth period of Table 1, when the additional fare SC occurs, the first additional fare SC1 and the second additional fare SC2 may be allocated to the driver and the occupant in the same manner, and the detailed description will be omitted.

As another example, the third period of Table 1 ends at the point where the third occupant C rides, and the ended service period (third period) may be a set state capable of calculating the fare. That is, the third period may be an example of setting for the period where the occupants riding in the sharing vehicle 1 are in plural (step S113).

In the first period of Table 1, the server 400 calculates a sharing time fare (2,000 won=2 hr×1,000 won) for the third period. In addition, the server 400 may calculate a first time fare, 500 won (500 won=2,000 won×1/4) paid by the driver by applying the first ratio DTR, 1/4 to the sharing time fare (FC=2000 won) for the second period. The server 400 may calculate a second time fare, 500 won (500 won=2,000 won×1/4) paid by each of the first occupant A, the second occupant B, and the third occupant C by applying the second ratio DTR, 1/4 to the sharing time fare (FC=2000 won) for the third period.

According to an exemplary embodiment, when the plurality of occupants (N>1) ride in the sharing vehicle 1, the server 400 may calculate a second distance fare paid by each of the plurality of occupants by applying the fourth ratio PDRt corresponding to each of the plurality of occupants to the sharing distance fare (AC=2,000 won) calculated based on a reference distance.

TABLE 2

| | Equation | | |
|---|---|---|---|
| Third period & | (B = 0, C = 0.5, N = 3) | Computing process | |
| distance fare (AC) | AC = 10 (km) × 200 (won/km) | AC = 2,000 won | Computing result |
| First occupant (A) (t = 1) | $( 1 - B ) \times \frac{{C}^{2}}{1 + C + {C}^{2}} \times AC$ | $\frac{{0.5}^{2}}{1 + 0.5 + {0.5}^{2}} \times 2000$ | 286 won |
| Second occupant (B) (t = 2) | $( 1 - B ) \times \frac{{C}^{1}}{1 + C + {C}^{2}} \times AC$ | $\frac{{0.5}^{1}}{1 + 0.5 + {0.5}^{2}} \times 2000$ | 571 won |
| Third occupant (C) ( t = 3) | $( 1 - B ) \times \frac{1}{1 + C + {C}^{2}} \times AC$ | $\frac{1}{1 + 0.5 + {0.5}^{2}} \times 2000$ | 1,143 won |

Table 2 above is a table for showing a process of deriving the distance fare AC for the third period of Table 1 above in detail. Equation for each of the first occupant A, the second occupant B, and the third occupant C may be calculated based on Equation 4.

Referring to Table 2 above, since the first occupant A first rode, the riding order t is 1, and the riding order t of the second occupant B is 2, and the riding order t of the third occupant C is 3. The server 400 may allocate 286 won to the first occupant A by applying a fourth ratio PDR1, 0.25/1.75 (about 0.14) corresponding to the first riding order to the sharing distance fare (AC=2,000 won). The server 400 may allocate 571 won (rounding off below the decimal point) to the second occupant B by applying a fourth ratio PDR2, 0.5/1.75 (about 0.28) corresponding to the second riding order to the sharing distance fare (AC=2,000 won). The server 400 may allocate 1,143 won (rounding off below the decimal point) to the third occupant C by applying a fourth ratio PDR3, 1/1.75 (about 0.57) corresponding to the third riding order to the sharing distance fare (AC=2,000 won). At this time, the server 400 may calculate the third ratio DDR, the fourth ratio PDR1 corresponding to the first riding order, the fourth ratio PDR2 corresponding to the second riding order, and the fourth ratio PDR3 corresponding to the third riding order by substituting the second parameter (B=0), the third parameter (C=0.5), and the occupant number N (3) for Equations 3 and 4, respectively.

In the third period of Table 1, the server 400 may calculate a hailing fare, 858 won paid by the first occupant A by multiplying the second distance fare (286 won=2,000 won×0.25/1.75) paid by the first occupant A by a predetermined multiple (e.g., n=3). In addition, the server 400 may calculate a hailing fare, 1,713 won paid by the second occupant B by multiplying the second distance fare (571 won=2,000 won×0.5/1.75) paid by the second occupant B by a predetermined multiple (e.g., n=3). In addition, the server 400 may calculate a hailing fare, 3,429 won paid by the third occupant C by multiplying the second distance fare (1,143 won=2,000 won×1/1.75) paid by the third occupant C by a predetermined multiple (e.g., n=3).

In the fare of the third period, the server 400 may calculate a driver fare, 500 won, paid by the driver by adding the first time fare (500 won) and the first distance fare (o won). In addition, the server 400 may calculate an occupant fare, 1,644 won, paid by the first occupant A by adding the second time fare (500 won), the second distance fare (286 won), and the hailing fare (858 won) corresponding to the first occupant A. In addition, the server 400 may calculate an occupant fare, 2,784 won, paid by the second occupant B by adding the second time fare (500 won), the second distance fare (571 won), and the hailing fare (1,713 won) corresponding to the second occupant B. In addition, the server 400 may calculate an occupant fare, 2,784 won, paid by the third occupant C by adding the second time fare (500 won), the second distance fare (1,143 won), and the hailing fare (3,429 won) corresponding to the third occupant C.

As yet another example, the fourth period of Table 1 ends at the point where the first occupant A rides, and the ended service period (fourth period) may be a set state capable of calculating the fare. That is, the fourth period may be an example of setting for the period where the occupants riding in the sharing vehicle 1 are in plural (step S113).

In the fourth period of Table 1, the server 400 may calculate a sharing time fare (1,000 won=1 hr×1,000 won) for the fourth period, a first time fare, 333 won (333 won=1,000 won×1/3) paid by the driver, and a second time fare 333 won (333 won=1,000 won×1/3) paid by each of the first occupant A and the second occupant B in the same method as the second period described above.

In the fourth period of Table 1, the server 400 may calculate a sharing distance fare (1,000 won=5 km×200 won/1 km) for the fourth period, a first distance fare (0 won) paid by the driver, a second distance fare (333 won=1,000 won×1/3) paid by the first occupant A first riding (t=1), and a second distance fare (667 won=1,000 won×2/3) paid by the second occupant B second riding (t=2) in the same method as the second period described above.

In the fourth period of Table 1, the hailing fare (1,000) paid by the first occupant A and the hailing fare (2,000) paid by the second occupant B may be calculated with respect to the fourth period in the same method as the second period described above.

In the fare of the fourth period, the server 400 may calculate a driver fare, 333 won, paid by the driver by adding the first time fare (333 won) and the first distance fare (0 won). In addition, the server 400 may calculate an occupant fare, 1,666 won, paid by the first occupant A by adding the second time fare (333 won), the second distance fare (333 won), and the hailing fare (1,000 won) corresponding to the first occupant A. In addition, the server 400 may calculate an occupant fare, 3,000 won, paid by the second occupant B by adding the second time fare (333 won), the second distance fare (667 won), and the hailing fare (2,000 won) corresponding to the second occupant B.

As yet another example, the fifth period of Table 1 ends at the point where the second occupant B rides, and the ended service period (fifth period) may be a set state capable of calculating the fare. That is, the fifth period may be an example of setting for the period where the occupant riding in the sharing vehicle 1 is single (step S111).

In the fifth period of Table 1, the server 400 may calculate a sharing time fare (1,000 won=1 hr×1,000 won) for the fifth period and a sharing distance fare (1,000 won=5 km×200 won/km) for the fifth period in the same method as the first period described above. In addition, the server 400 may calculate the first time fare (500 won) and the first distance fare (0 won) paid by the driver. In addition, the server 400 may calculate the second time fare (500 won), the second distance fare (1,000 won), and the hauling fare (3,000 won) paid by the second occupant B.

In the fare for the fifth period, the server 400 may calculate a driver fare, 500 won, paid by the driver by adding the first time fare (500 won) and the first distance fare (0 won). In addition, the server 400 may calculate an occupant fare, 4,500 won, paid by the second occupant B by adding the second time fare (500 won), the second distance fare (1,000 won), and the hailing fare (3,000 won) corresponding to the second occupant B.

Next, the server 400 stores the calculated drive fare and/or occupant fare (S115). For example, the server 400 may store a server storage unit 430 by mapping the driver fare and/or the occupant fare corresponding to the service period.

Next, the server 400 may determine whether the occupant get off from the sharing vehicle 1 (S117).

Next, as the determining result, when the occupant get off from the sharing vehicle 1 (S117, Yes), the server 400 may calculate a total occupant fare of the occupant who gets off (S119).

For example, referring to Table 1, when the first occupant A gets off from the start point of the fifth period (or the end point of the fourth period), the server 400 may calculate a total occupant fare of the first occupant A by adding the occupant fares calculated for the first occupant A in the first period, the second period, the third period, and the fourth period. That is, the server 400 may calculate a total occupant fare (18,977 won) of the first occupant A by adding the occupant fare (9,000 won) of the first occupant A in the first period, the occupant fare (6,667 won) of the first occupant A in the second period, the occupant fare (1,644 won) of the first occupant A in the third period, and the occupant fare (1,666 won) of the first occupant A in the fourth period.

Next, as the determining result, after the occupant does not get off from the sharing vehicle 1 (S117, No), or the total occupant fare for the get-off occupants are calculated (S119), the server 400 determines whether the car hailing service ends (S121).

For example, when the rental period while the driver rents the sharing vehicle 1 ends, since the driver may not provide the car hailing service to the sharing vehicle 1, the server 400 may determine that the car hailing service ended. However, it is not limited thereto, and in various situations, the server 400 may determine the end of the car hailing service.

Next, as the determining result, when the car hailing service does not end (S121, No), the server 400 may repeat from step S103.

Next, as the determining result, when the car hailing service ends (S121, Yes), the server 400 calculates a total driver fare of the driver (S123).

For example, referring to Table 1, when it is assumed that the car hailing service ends when the fifth period ends, the server 400 may calculate a total driver fare by adding the driver fares calculated for the driver in the zeroth period, the first period, the second period, the third period, the fourth period, and the fifth period, respectively. That is, the server 400 may calculate a total driver fare (7,666 won) of the driver by adding the driver fare (4,000 won) in the zeroth period, the driver fare (1,000 won) in the first period, the driver fare (1,333 won) in the second period, the driver fare (500 won) in the third period, the driver fare (300 won) in the fourth period, and the driver fare (500 won) in the fifth period.

Embodiments are configured so that the hailing fare HC attributed to the driver is the same even when the driver takes the plurality of occupants together. Referring to Table 1, the total hailing fare attributed to the driver is 12,000 won in the second period where the driver drives at 20 km. In addition, the total hailing fare attributed to the driver is 6,000 won in the third period where the driver drives at 10 km. That is, the hailing fares attributed to the driver per 10 km in the second period and the third period are the same as 6,000. In summary, embodiments have an effect of preventing attempts of taking the plurality of occupants together for the driver's own profit when the driver provides the car hailing service.

In addition, embodiments are configured so that a share rate of the first riding occupant is smaller than that of the later riding occupant when the sharing distance fare AC is divided into the plurality of occupants (N>1) (see Equations 4 and 5 and Table 1). This may mean a reward for the first riding occupant who accepts inconvenience and allows the sharing of the later riding occupant. Alternatively, this may mean a reward for a problem in which the moving distance may increase while the first riding occupant rides in the sharing vehicle 1 due to the destination of the later riding occupant.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A vehicle terminal comprising:
an input/output unit configured to receive destination information from a driver using a car sharing vehicle provided by a car sharing service;
a position detection unit configured to detect a position of the sharing vehicle;
a control unit configured to calculate a use time of the sharing vehicle and provide information of whether an occupant is present in the sharing vehicle and about a distance moved based on the detected positions; and
a vehicle communication unit configured to communicate with a server and transmit the use time, the information of whether the occupant is present and about the distance moved so that a first time fare to be allocated to the driver is calculable by applying a first ratio to a sharing time fare calculated based on the use time of the sharing vehicle, a second time fare to be allocated to the occupant is calculable by applying a second ratio to the sharing time fare, a first distance fare allocated to the driver is calculable by applying a third ratio to a sharing distance fare calculated based on a moving distance of the sharing vehicle, a second distance fare allocated to the occupant is calculable by applying a fourth ratio to the sharing distance fare, and a hailing fare for a car hailing service allocated to the occupant is calculable by multiplying the second distance fare by a predetermined multiple.

2. The vehicle terminal of claim 1, wherein the sharing fare includes the sharing time fare and the sharing distance fare.

3. The vehicle terminal of claim 1, wherein the server is configured to calculate an occupant fare allocated to the occupant by adding the second time fare, the second distance fare, and the hailing fare when the occupant gets off the sharing vehicle.

4. The vehicle terminal of claim 1, wherein the server is configured to calculate a driver fare allocated to the driver by adding the first time fare and the first distance fare when the driver ends the driving of the sharing vehicle.

5. The vehicle terminal of claim 1,
wherein the first ratio is calculated by substituting a occupant number N, 1 for the following equation:
$$DTR = \frac{A}{A + ( 1 - A ) \times N} ,$$
wherein the second ratio is calculated by substituting the occupant number N, 1 for the following equation:
$$PTR = \frac{1 - A}{A + ( 1 - A ) \times N} ,$$
and
wherein DTR represents the first ratio, 0≤A≤1, N represents the occupant number, and PTR represents the second ratio.

6. The vehicle terminal of claim 1,
wherein the third ratio is calculated by substituting an occupant number N, 1 for the following equation:
DDR=B,
wherein the fourth ratio is calculated by substituting the occupant number N, 1 for the following equation:
$${PDR}_{t} = ( 1 - B ) \times \frac{{C}^{N - t}}{{\sum }_{k = 1}^{N} {C}^{k - 1}} ,$$
and
wherein DDR represents the third ratio, 0≤B≤1, N represents the occupant number, 0≤C≤1, t is a natural number corresponding to an order in which the occupant rides in the sharing vehicle, and PDRt represents the fourth ratio applied to a t-th occupant riding in the sharing vehicle.

7. A system for calculating a sharing fare for providing a car sharing service to a driver and a hailing fare for providing a car hailing service to an occupant, the system comprising:
a server configured to:
calculate a first time fare to be allocated to the driver by applying a first ratio to a sharing time fare calculated based on a use time of a sharing vehicle,
calculate a second time fare to be allocated to the occupant by applying a second ratio to the sharing time fare,
calculate a first distance fare allocated to the driver by applying a third ratio to a sharing distance fare calculated based on a moving distance of the sharing vehicle,
calculate a second distance fare allocated to the occupant by applying a fourth ratio to the sharing distance fare, and
calculate a hailing fare for a car hailing service allocated to the occupant by multiplying the second distance fare by a predetermined multiple.

8. The system of claim 7, wherein the sharing fare includes the sharing time fare and the sharing distance fare.

9. The system of claim 7, wherein the server is configured to calculate an occupant fare allocated to the occupant by adding the second time fare, the second distance fare, and the hailing fare when the occupant gets off the sharing vehicle.

10. The system of claim 7, wherein the server is configured to calculate a driver fare allocated to the driver by adding the first time fare and the first distance fare when the driver ends the driving of the sharing vehicle.

11. The system of claim 7,
wherein the first ratio is calculated by substituting an occupant number N, 1 for the following equation:
$$DTR = \frac{A}{A + ( 1 - A ) \times N} ,$$
wherein the second ratio is calculated by substituting the occupant number N, 1 for the following equation:
$$PTR = \frac{1 - A}{A + ( 1 - A ) \times N} ,$$
and
wherein DTR represents the first ratio, 0≤A≤1, N represents the occupant number, and PTR represents the second ratio.

12. The system of claim 7,
wherein the third ratio is calculated by substituting an occupant number N, 1 for the following equation 3:
DDR=B,
wherein the fourth ratio is calculated by substituting the occupant number N, 1 for the following equation:
$${PDR}_{t} = ( 1 - B ) \times \frac{{C}^{N - t}}{{\sum }_{k = 1}^{N} {C}^{k - 1}} ,$$
and
wherein DDR represents the third ratio, 0≤B≤N represents the occupant number, 0≤C≤1, t is a natural number corresponding to an order in which the occupant rides in the sharing vehicle, and PDRt represents the fourth ratio applied to a t-th occupant riding in the sharing vehicle.

13. A method for calculating a sharing fare for providing a car sharing service to a driver and a hailing fare for providing a car hailing service to at least one occupant, the method comprising:
determining whether to divide a service period into smaller set service periods according to changes in occupants riding in a sharing vehicle provided by the car sharing service,
determining whether the occupant riding in the sharing vehicle is one or more, and
calculating a driver fare allocated to the driver and an occupant fare allocated to the occupant when it is determined that the occupant is a single occupant,
wherein calculating the driver fare allocated to the driver and the occupant fare allocated to the occupant comprises:
calculating a first time fare allocated to the driver by applying a first ratio to a sharing time fare calculated based on a use time of the sharing vehicle and calculating a second time fare allocated to the occupant by applying a second ratio to the sharing time fare,
calculating a first distance fare allocated to the driver by applying a third ratio to a sharing distance fare calculated based on a moving distance of the sharing vehicle and calculating a second distance fare allocated to the occupant by applying a fourth ratio to the sharing distance fare, and
calculating the hailing fare allocated to the occupant by multiplying the second distance fare by a predetermined multiple.

14. The fare calculation method of claim 13, wherein the sharing fare includes the sharing time fare and the sharing distance fare.

15. The fare calculation method of claim 13, wherein the driver fare includes the first time fare and the first distance fare, and wherein the occupant fare includes the second time fare, the second distance fare, and the hailing fare.

16. The fare calculation method of claim 13, further comprising:
calculating the driver fare allocated to the driver and the occupant fare allocated to the occupant when it is determined that the occupant is a plurality of occupants,
wherein calculating the driver fare allocated to the driver and the occupant fare allocated to each of the plurality of occupants comprises:
calculating a first time fare allocated to the driver by applying a first ratio to a sharing time fare calculated based on the use time of the sharing vehicle and calculating a second time fare allocated to each of the plurality of occupants by applying a second ratio to the sharing time fare,
calculating a first distance fare allocated to the driver by applying a third ratio to a sharing distance fare calculated based on the moving distance of the sharing vehicle and calculating a second distance fare allocated to each of the plurality of occupants by applying a fourth ratio corresponding to each of the plurality of occupants to the sharing distance fare, and
calculating the hailing fare allocated to each of the plurality of occupants by multiplying the second distance fare allocated to each of the plurality of occupants by a predetermined multiple.

17. The fare calculation method of claim 16, wherein the fourth ratio corresponding to each of the plurality of occupants is calculated based on an order in which each of the plurality of occupants rides in the sharing vehicle.

18. The fare calculation method of claim 17,
wherein the driver fare includes the first time fare and the first distance fare, and
wherein the occupant fare allocated to each of the plurality of occupants includes the second time fare, the second distance fare, and the hailing fare corresponding to each of the plurality of occupants.

19. The fare calculation method of claim 13,
wherein the first ratio is calculated by the following equation:
$$DTR = \frac{A}{A + ( 1 - A ) \times N} ,$$
wherein the second ratio is calculated by the following equation:
$$PTR = \frac{1 - A}{A + ( 1 - A ) \times N} ,$$
and
wherein DTR represents the first ratio, 0≤A≤1, N represents the occupant number, and PTR represents the second ratio.

20. The fare calculation method of claim 13,
wherein the third ratio is calculated by the following equation:
DDR=B,
wherein the fourth ratio is calculated by the following equation:
$${PDR}_{t} = ( 1 - B ) \times \frac{{C}^{N - t}}{{\sum }_{k = 1}^{N} {C}^{k - 1}} ,$$
and
wherein DDR represents the third ratio, 0≤B≤1, N represents the occupant number, 0≤C≤1, t is a natural number corresponding to an order in which the occupant rides in the sharing vehicle, and PDRt represents the fourth ratio applied to a t-th occupant riding in the sharing vehicle.
